(19) United States
(12) Patent Application Publication
(10) Pub. No.: US 2019/0352869 A1
(43) Pub. Date: Nov. 21, 2019

(54) APPARATUS FOR CREATING A DEDICATED LANE FOR AN EMERGENCY VEHICLE

(71) Applicants: Saransh Gupta, Uttar Pradesh (IN); Siddhant Gupta, Uttar Pradesh (IN)

(72) Inventors: Saransh Gupta, Uttar Pradesh (IN); Siddhant Gupta, Uttar Pradesh (IN)

(21) Appl. No.: 16/472,938

(22) PCT Filed: Dec. 23, 2017
(86) PCT No.: PCT/IB2017/058389

§ 371 Date: Jun. 24, 2019

(30) Foreign Application Priority Data
Dec. 26, 2016 (IN) 201611044287

(51) Int. Cl. E01F 15/00; E01F 9/658; G08G 1/09

(52) U.S. Cl. CPC E01F 15/006; G08G 1/09; E01F 15/003; E01F 9/658

(57) ABSTRACT

Embodiments of the present disclosure provide an apparatus that enables temporary creation of a dedicated lane on a road for providing an uninterrupted passage to emergency vehicles. An aspect of the present disclosure pertains to an apparatus including a deployable asset that can be configured in a first position and in a second position, said first position being configured when said asset is not deployed and hangs vertically by means of a support mechanism, said second position being configured when said asset is deployed on a road by being vertically brought down from said first position such that upon deployment, said asset enables temporary creation of a dedicated lane on the road to enable uninterrupted passage of a defined vehicle.

### TECHNICAL FIELD

The present disclosure relates to the field of transportation through roadways. In particular, the present disclosure provides an apparatus, system, and method that enables temporary creation of a dedicated lane on a road for providing an uninterrupted passage to emergency vehicles.

### BACKGROUND

Emergency vehicles are designated and authorized to respond to in emergency situations. Such vehicles can include ambulances, fire trucks, police vehicles, and the likes. Response time of such vehicles is a crucial factor as any delay in said response time can lead to life threatening scenario. For instance, when a serious patient is being transported in an ambulance, any delay in reaching the hospital can have life and death consequences. Therefore, to prevent any delay in transportation of emergency vehicles, said vehicles are generally equipped with emergency lights, sirens, etc. that can notify other vehicles on the road for immediate attention and quick passage.

An emergency vehicle signaling system has been developed in the past that enables an emergency vehicle to transmit a RF signal having a narrow cone calculated to be received in a second vehicle. The receiver for the second vehicle is equipped with an indicator in the form of a white light that blinks in order to alert the driver of the emergency vehicle that the RF signal which it is transmitting has been received by the second vehicle. Accordingly, occupants of the second or non-emergency vehicle are made aware of the presence of the emergency vehicle while the visual indicator confirms reception of the RF signal. Another emergency vehicle signaling system has been developed that uses a transmitter in an emergency vehicle that is capable of producing an omni-directional radio signal and triggering receivers in non-emergency vehicles with a variable intensity audible warning relative to the distance to the emergency vehicle.

However, said signaling system may not create a dedicated path for an emergency vehicle and may not indicate a clearance path to non-emergency vehicles. Random movements of various non-emergency vehicles may lead to a turbulent situation that may likely cause obstruction in the path of emergency vehicle. Therefore, an advancement in the field of transportation of emergency vehicles is required that can aid in providing an unobstructed and uninterrupted path for timely response of the emergency vehicles, thereby indicating a clearance path to the non-emergency vehicles.

### OBJECTIVES OF THE PRESENT DISCLOSURE

An object of the present disclosure is to provide an apparatus that can enable temporary creation of a dedicated lane on the road for providing an uninterrupted passage to an emergency vehicle.

Another object of the present disclosure is to provide an apparatus that can ensure safe and quick passage to an emergency vehicle.

Another object of the present disclosure is to provide an apparatus that can notify vehicles other than the emergency vehicle for immediate attention.

Another object of the present disclosure is to provide an apparatus that can indicate a passage to other vehicles such that an emergency vehicle can pass through a dedicated passage.

Another object of the present disclosure is to provide an apparatus that can be integrated with existing structures, which are installed on the road.

These and other objects of the present disclosure will become readily apparent from the following detailed description taken in conjunction with the accompanying drawings.

### SUMMARY

Embodiments of the present disclosure provide an apparatus that enables temporary creation of a dedicated lane on a road for providing an uninterrupted passage to emergency vehicles.

An aspect of the present disclosure pertains to an apparatus including a deployable asset that can be configured in a first position and in a second position, said first position being configured when said asset is not deployed and hangs vertically by means of a support mechanism, said second position being configured when said asset is deployed on a road by being vertically brought down from said first position such that upon deployment, said asset enables temporary creation of a dedicated lane on the road to enable uninterrupted passage of a defined vehicle.

In an embodiment, defined vehicle can be selected from a set of vehicles including any or a combination of emergency vehicles, ambulances, and vehicles designed as requiring the uninterrupted passage for passing through.

In an embodiment, said asset can be deployed in conjunction with deployment of a set of assets that are in proximity to said apparatus.

In an embodiment, said asset can be deployed at a first trigger event or at a first pre-defined time before said defined vehicle arrives at the asset, and can be returned back to the first position at a second trigger event or at a second pre-defined time after passing by of the vehicle.

In an embodiment, the asset can be deployed after said apparatus receives a deployment instruction from a computing device, said instruction can be received through a wireless or a wired connection.

In an embodiment, the computing device can be a server or cloud that can be operatively coupled with the vehicle and upon receiving real-time location coordinates of the vehicle, said computing device can issue said deployment instruction to the apparatus.

In an embodiment, the computing device can be configured in the vehicle.

In an embodiment, the computing device can receive destination location from said vehicle, and based on current location of said vehicle and said destination location, the computing device can determine an optimal travel path for said vehicle, and issue one or more deployment instructions to respective apparatuses based on said determined optimal travel path.

In an embodiment, said asset can be a traffic cone marker.

In an embodiment, said apparatus can be operatively coupled with a street light.

In an embodiment, said asset can be moved between said first position and said second position using a pulley/motor system.

In an embodiment, said asset can have a reflective surface for better visibility at night.

In an embodiment, said asset can comprise any or a combination of a display, a light, or can be configured to generate an audio signal to alert other vehicles on the road that said vehicle is approaching and instructing emptying of said dedicated lane.

In an embodiment, said apparatus can be operated by means of a switch, activation of which deploys said asset on the road.

Exemplary aspects of the present disclosure further relate to a system configured to enable systematic deployment of an asset that is positioned at a defined location from a first position to a second position, wherein the systematic deployment is done when the system receives a signal that is representative of a defined vehicle approaching the defined location. The first position is configured when the asset is not deployed and hangs vertically by means of a support mechanism, whereas the second position is configured when the asset is deployed on a road by being vertically brought down from the first position such that upon said systematic deployment, the assets from one or multiple apparatuses enables temporary creation of a dedicated lane on the road to enable uninterrupted passage of said defined vehicle.

Exemplary aspects of the present disclosure further relate to a method comprising the steps of receiving, at a computing device, a signal representative of a defined vehicle approaching a defined location; and enabling, using said computing device, deployment of an asset that is operatively coupled with said computing device and positioned at said defined location from an initial position to a desired position, said initial position being configured when said asset is not deployed and hangs vertically by means of a support mechanism, said desired position being configured when said asset is deployed on a road by being vertically brought down from said initial position such that upon deployment, said asset enables temporary creation of a dedicated lane on the road to enable uninterrupted passage of said defined vehicle.

Various objects, features, aspects and advantages of the inventive subject matter will become more apparent from the following detailed description of preferred embodiments, along with the accompanying drawing figures in which like numerals represent like components.

### BRIEF DESCRIPTION OF DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary representation of an apparatus in accordance with an exemplary embodiment of the present disclosure.

FIGS. 2A-D illustrate exemplary architectures for controlling the proposed apparatus in accordance with an embodiment of the present disclosure.

FIGS. 3A-C illustrate exemplary representations for creation of a dedicated lane for an emergency vehicle in accordance with an embodiment of the present disclosure.

FIGS. 4A-B illustrate exemplary representations indicate an alarming system operatively coupled with the proposed apparatus in accordance with an embodiment of the present disclosure.

FIGS. 5A-C illustrate exemplary representations for deployment of assent according to passage of an emergency vehicle in accordance with an embodiment of the present disclosure.

FIG. 6 is a flow diagram illustrating a process for creation of an uninterrupted passage for an emergency vehicle in accordance with an embodiment of the present disclosure.

FIG. 7 illustrates an exemplary computer system utilized for controlling deployment of an asset in accordance with embodiments of the present disclosure.

### DETAILED DESCRIPTION

In the following description, numerous specific details are set forth in order to provide a thorough understanding of embodiments of the present invention. It will be apparent to one skilled in the art that embodiments of the present invention may be practiced without some of these specific details.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Embodiments of the present disclosure provide an apparatus that enables temporary creation of a dedicated lane on a road for providing an uninterrupted passage to emergency vehicles.

An aspect of the present disclosure pertains to an apparatus including a deployable asset that can be configured in a first position and in a second position, said first position being configured when said asset is not deployed and hangs vertically by means of a support mechanism, said second position being configured when said asset is deployed on a road by being vertically brought down from said first position such that upon deployment, said asset enables temporary creation of a dedicated lane on the road to enable uninterrupted passage of a defined vehicle.

In an embodiment, defined vehicle can be selected from a set of vehicles including any or a combination of emergency vehicles, ambulances, and vehicles designed as requiring the uninterrupted passage for passing through.

In an embodiment, said asset can be deployed in conjunction with deployment of a set of assets that are in proximity to said apparatus.

In an embodiment, said asset can be deployed at a first pre-defined time before said defined vehicle arrives at the asset, and can be returned back to the first position at a second pre-defined time after passing by of the vehicle.

In an embodiment, the asset can be deployed after said apparatus receives a deployment instruction from a computing device, said instruction can be received through a wireless or a wired connection.

In an embodiment, the computing device can be a server or cloud that can be operatively coupled with the vehicle and upon receiving real-time location coordinates of the vehicle, said computing device can issue said deployment instruction to the apparatus.

In an embodiment, the computing device can be configured in the vehicle.

In an embodiment, the computing device can receive destination location from said vehicle, and based on current location of said vehicle and said destination location, the computing device can determine an optimal travel path for said vehicle, and issue one or more deployment instructions to respective apparatuses based on said determined optimal travel path.

In an embodiment, said asset can be a traffic cone marker.

In an embodiment, said apparatus can be operatively coupled with a street light.

In an embodiment, said asset can be moved between said first position and said second position using a pulley/motor system.

In an embodiment, said asset can have a reflective surface for better visibility at night.

In an embodiment, said asset can comprise any or a combination of a display, a light, or can be configured to generate an audio signal to alert other vehicles on the road that said vehicle is approaching and instructing emptying of said dedicated lane.

In an embodiment, said apparatus can be operated by means of a switch, activation of which deploys said asset on the road.

Exemplary aspects of the present disclosure further relate to a system configured to enable deployment of an asset that is positioned at a defined location from a first position to a second position, wherein the deployment is done when the system receives a signal that is representative of a defined vehicle approaching the defined location. The first position is configured when the asset is not deployed and hangs vertically by means of a support mechanism, whereas the second position is configured when the asset is deployed on a road by being vertically brought down from the first position such that upon deployment, the asset enables temporary creation of a dedicated lane on the road to enable uninterrupted passage of said defined vehicle.

Exemplary aspects of the present disclosure further relate to a method comprising the steps of receiving, at a computing device, a signal representative of a defined vehicle approaching a defined location; and enabling, using said computing device, deployment of an asset that is operatively coupled with said computing device and positioned at said defined location from an initial position to a desired position, said initial position being configured when said asset is not deployed and hangs vertically by means of a support mechanism, said desired position being configured when said asset is deployed on a road by being vertically brought down from said initial position such that upon deployment, said asset enables temporary creation of a dedicated lane on the road to enable uninterrupted passage of said defined vehicle.

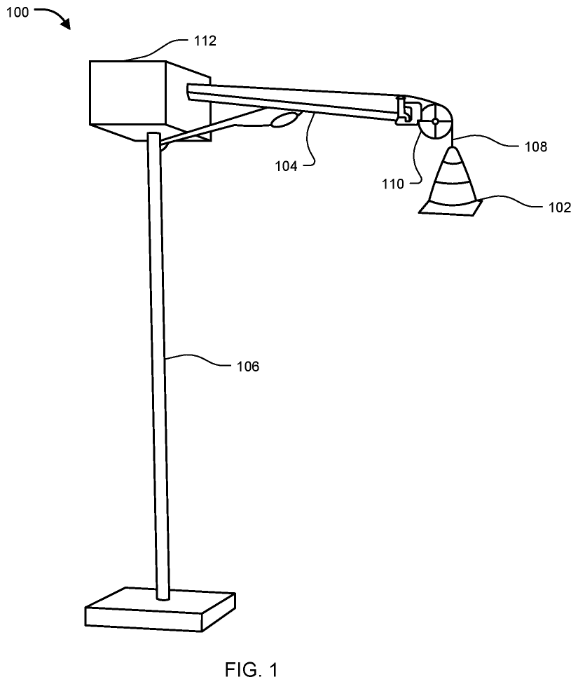

FIG. 1 illustrates an exemplary representation of an apparatus in accordance with an exemplary embodiment of the present disclosure.

In an aspect, the proposed apparatus 100 can include a deployable asset 102 that can be any or a combination of a traffic cone marker, a barricade, a box, or any other object that can be used for creating a barrier or temporary closure on a road. Further, the asset 102 can also provide warning/alert/guidance/information to drivers of various vehicles present on the road. The asset 102 can have a reflective surface that can be made of retro-reflective sheets that can be designed to reflect light from headlights of the vehicle back to the driver so that the asset 102 can be visible during the night.

In an aspect, the asset 102 can hang vertically by means of a support mechanism 104, which, in an instance, can be a rigid arm such as a metal rod that can be coupled with a pole 106 attached to ground. The support mechanism 104 can be configured at a height such that any part of the apparatus at normal times does not interfere with various vehicles present on the road. In an embodiment, length of the support mechanism 104 can be such that the length covers a distance of single lane of the road from the edge of the road such that a vehicle can pass through the lane when the asset 102 is deployed on the road. For example, length of the support mechanism 104 can include distance of the pole 106 from the edge of the road on which the support mechanism 104 is mounted and width of the lane for providing a passage to the vehicle.

In an embodiment, the support mechanism 104 can include a hydraulic or pneumatic system to vary length of the support mechanism 104. Length of the support mechanism 104 can be altered in accordance with dimension of the vehicle that has to pass through the passage. For example, when a vehicle having a wider dimension has to pass, the length of the support mechanism 104 can be increased such that no obstruction occurs in path of the vehicle.

In an aspect, the asset 102 can be configured in a first position and can be deployed in a second position. The first position (also referred to as normal/initial position, hereinafter) can be the position/configuration of the asset 102 when the asset 102 hangs vertically by means of the support mechanism 104 and the second position (also referred to as deployed/desired position, hereinafter) can be the position of the asset 102 when the asset is vertically brought down and deployed on the road. In an embodiment, the asset 102 can further be deployed in an intermediate position (also referred to as ready position hereinafter). The intermediate position can be the position of the asset 102 where height of the asset from ground is selected such that the asset 102 does not interfere with the other vehicles.

In an embodiment, a rope and pulley mechanism can be used for deployment of the asset 102 to the deployed position and to bring the asset 102 back in the normal position. The asset 102 can be coupled with a rope 108 that can be a light line or a strong cable depending on weight of the asset 102. Further, the surface of the rope 102 can be made of reflective material to provide better visibility during night time. Additionally, rotation of a pulley 110 can be controlled using a driving mechanism that can be contained in a protective casing 112.

In an aspect, the driving mechanism can include a motor that can be operated by means of a switch to deploy the asset 102 on the road. The driving mechanism can also include a communication unit that can receive trigger signals for the switch through a network. The communication unit can enable setting up of any network prototype for example, Wi-Fi, Bluetooth, GPS, GSM, GPRS, radio frequency communications, power line communications and the like. The motor can be any of an AC motor or a DC motor, whose shaft can be operatively coupled with the shaft of the pulley 110. Further, the shaft of the motor can also be coupled with a cylindrical drum on which part of the rope 108 can be rotated. It would be appreciated that the driving mechanism can include additional components such as gear box, power supply, wires, battery, solar cells, diodes, relays, microcontroller, radio frequency antenna, etc. that can aid in controlling rotation of the pulley 110 for deployment of the asset 102.

Though embodiments of the present disclosure are explained with the help of rope and pulley mechanism driven by a motor, any other mechanism known in the art such as hydraulic mechanism, pneumatic mechanism, chain drive mechanism and the like that can be used for deployment of the asset 102 are well within the scope of the present disclosure.

According to an implementation, plurality of proposed apparatuses can be installed on edge of the road. When a set of assets that are part of the plurality of proposed apparatuses that are in close proximity, are deployed on the road, a dedicated lane can be created that can provide an uninterrupted passage to a defined vehicle (also referred to as “emergency vehicle” hereinafter). The defined vehicle can be selected from a set of vehicles that can include fire trucks, ambulances, police vehicles and other vehicles that are designed to respond in emergency situations and require an uninterrupted passage for passing through. When a set of asset are in the intermediate position and/or deployed position, vehicles present on the road can be alerted to vacate the dedicated lane created thereof to provide uninterrupted passage to the emergency vehicle.

It would be appreciated that although embodiments of the present disclosure are explained in terms of providing a dedicated lane to the emergency vehicle, the scope of the present discourse is not limited in any way whatsoever, and any other form of application of the deployment of the assets such as, for blocking a road in an event of an accident or during construction activities of the road is well within the scope of the present disclosure.

According to an implementation, the plurality of proposed apparatuses can be configured with existing structures that are installed on the road, including but not limited to street lights, traffic lights, over head bridges, metro bridges, wires, hoardings and the like. In a preferred embodiment, the apparatuses can be operatively coupled with street lights which can reduce cost, time and effort to install the apparatuses.

In an embodiment, the apparatus 102 can be operatively coupled with an alarming system that can comprise any or a combination of a display, a light, and the like. Additionally or alternatively, the alarming system can be configured to generate an audio-visual signal to alert other vehicles on the road about the proximity of the emergency vehicle and can be used for instructing other vehicle to vacate the dedicated lane. In an exemplary implementation, the alarming system can be configured with the protective casing 112, such that various surfaces of the protective casing 112 can be utilized for displaying the alert messages. In an embodiment, surfaces of the protective casing 112 can be utilized for displaying informative content such as advertisements, general awareness information, weather reports, traffic information, air quality information and the likes.

In an implementation, the protective casing 112 can be mounted on a suitable height, such that proper indication can be provided to various vehicles present on the road. In an instance, the protective casing 112 can be mounted on the top of the pole 106. In another instance, the protective casing 112 can be mounted at any suitable height on the pole 106. In another exemplary implementation, the alarming system can be configured with the asset 102 to enable the asset 102 to generate audio-visual signals when the asset 102 is in the deployed position.

According to an implementation, when an emergency vehicle travelling towards the proposed apparatus 100 reaches in proximity of the said apparatus 100, the switch can be triggered to operate the motor. The shaft of the motor can rotate the pulley 110 and the cylindrical drum accommodating the rope 108 can start rotating in clockwise direction that can result into movement of the rope 108 in downward direction to deploy the asset 102, such that a lane can be created on the road for the emergency vehicle to pass through. At the same time, other vehicles on present on the road can vacate the lane created for the emergency vehicle by moving to other lanes of the road. Once the emergency vehicle crosses the said apparatus 100, the motor can enable rotation of the cylindrical drum in counter-clockwise direction and the pulley 110 can be rotated to effect movement of the asset 102 in upward motion such that the asset 102 is brought back to the normal position.

In an embodiment, the driving mechanism can also include a microcontroller that can be configured to generate switching signals for deployment of the asset 102 after a defined time interval. For example, when the asset 102 is deployed, a period of say 5 minutes can be kept for the emergency vehicle to pass through and after expiry of said period, the microcontroller can automatically generate switching signals so as to bring back the asset 102 to the normal position.

In an exemplary implementation, deployment of the proposed asset 102 can either be manually controlled, for instance, by sending initiation signal/deployment instruction/switching signal through power line connected for power supply in a power line communication network or can be done automatically based on trigger/actuation signals that the apparatus 100 receives from a computing device. Such a computing device can be, for instance, a server (or a cloud or a central computing device) that can be operatively coupled through wireless signals with one or more end-user computing devices that are configured in/with the emergency vehicles such that the end-user computing devices can transmit intimations to the server indicating current location and/or destination location, based on which the server can determine an optimal path for the emergency vehicle. Along with informing such optimal path to the vehicle, the computing device can also deploy the configured assets at a defined time before said emergency vehicle passes through the asset and take the asset back to non-deployed position a second defined time after the vehicle has passed through. The assets can therefore be deployed wirelessly based on instructions received from the server/computing device. Such deployment, as can be envisaged, can have numerous implementations, wherein, for instance, the emergency vehicle can communicate directly with the proposed apparatus 100, wherein the apparatus 100 can include a wireless transmitter/receiver/transceiver (not shown) and can accordingly follow instructions from the emergency vehicle. In another implementation, emergency vehicle can indicate to the server about the route that the emergency vehicle plans to follow, based on which the server determines the assets that would need to be deployed along the route and issues instructions accordingly. Once the assets are deployed, normal (non-emergency vehicles/other) vehicles can be given a defined amount of time to move into the other (non-dedicated) lanes such that only the desired emergency vehicle passes through the dedicated lane created by deployment of the assets.

It would also be appreciated that one or more assets can be logically grouped together such that all assets of a defined group (or sub-group) can be deployed together and then taken back to their initial position. As a result, groups of assets can be deployed as the emergency vehicle passes through a defined route. As mentioned above, the route can either be determined by the emergency vehicle itself or intimated to the server for controlled deployment of the assets or can be determined by the server/cloud and intimated to the emergency vehicle. Further, the server can be coupled with a database that can aid in storing/accessing/determining all possible routes of the emergency vehicle, information of pertaining to the apparatuses, location of the apparatuses, location/details of various computing devices that can provide deployment instructions for various assets (or group of assets), time in deployment of the assets, real-time traffic conditions etc. It would be appreciated that as server of the present disclosure would access database of where assets are deployed or are working, route determination may be performed by the server so as to enable the emergency vehicle to pass through such a route that has the maximum number of deployable assets, enabling faster transportation of the emergency vehicle so as to reduce travel time of the emergency vehicle.

In an exemplary aspect, control of the proposed asset 102/apparatus 100 can be performed in conjunction with street lights, wherein, in an aspect, the proposed asset can be operatively coupled with a respective street light such that street light gives the necessary support to the asset 102, and a common Programmable Logic Controller (PLC) can be configured to control deployment of the asset 102. Such a PLC can either be configured in the street light itself and be communicatively coupled with the server, or can be configured in any other device that can enable PLC based deployment/control of the asset. Further, PLC can take inputs from power line that provides power supply to street lights through power line communication networks. In an exemplary aspect, a PLC is a digital operating electronic apparatus that uses a programmable memory for internal storage of instruction for implementing specific function such as logic, sequencing, timing, counting and arithmetic to control through analog or digital input/output modules various types of machines or process. There are different types of PLC'S used for various applications such as, for instance, XD 26 PLC can be used to control the Street Lighting System. In an aspect, PLC is typically located in the field close to the processing unit, said processing unit, in context of the present invention, being configured in the apparatus 100, wherein the PLCs can be small with a simple operator interface such as a button switch that can be used to deploy the asset on road to create the dedicated lane, and retract the asset to enable normal road to be resumed. PLCs can also be configured with analog to digital conversion capability and provided sufficient logic to configure simple control loops. In an aspect, the proposed PLC can be a small PLC that can be configured as a relay replacement and provides a reliable control to standalone section of process, or can be a medium sized PLC that performs all the relay replacement functions along with performing functions like counting, timing and complex mathematical applications. Most medium sized PLCs can perform Proportional-Integral-Derivative (PID), feed forward, and control function as well. PLCs can now have date highway capabilities and can function as well in Distributed Control System (DCS) environment. As mentioned above, a typical PLC comprises a processor or controller, one or more Input/Output (I/O) Modules, chassis or backplane, power supply, and a programming software that can be configured to execute in a computing device. PLCs can further include a network interface so that they can communicate with one or more devices such as the server or the emergency vehicles in the present case. In an aspect, PLCs can be designed to eliminate assembly line relays during model changeovers. The operation of PLC can be easier than the relay panels, which feature reduces the installation and operational cost of the control system compared with the electromechanical relay systems.

In an aspect, in order to deploy an asset, system of present invention can include a relay that is an electrically operated switch, and uses an electromagnet to mechanically operate a switch, but other operating principles are also used, such as solid-state relays. Relays can be used where it is necessary to control a circuit by a separate low-power signal, or where several circuits must be controlled by one signal, such as in case where multiple assets need to be deployed as part of the present invention through a single instruction. In an aspect, relay of the present disclosure can be used to directly control an electric motor or other loads (referred to as a contactor), wherein, Solid-state relays control power circuits with no moving parts, instead using a semiconductor device to perform switching. Relays with calibrated operating characteristics and sometimes multiple operating coils are used to protect electrical circuits from overload or faults; in modern electric power systems these functions are performed by digital instruments referred to as protective relays. It would be appreciated that relays or any other configuration that can enable aspects of the present invention are well within the scope of the present disclosure.

Aspects of the present disclosure include a trigger circuit that has two states: a first state that actuates the switching means to deploy the proposed apparatus or a group of apparatuses, and a second state that actuates the trigger means to being back the apparatus or the group of apparatuses back to the initial position. There are means for biasing the trigger circuit into one of the states and there are photoelectric sensing means for varying the bias on the trigger circuit to drive it into the other state in response to receipt of instruction from a central server.

PLC of the present disclosure can communicate with the server so as to receive instructions from the server as to when to deploy/retract the apparatus, based on which it controls processors of one or more apparatus, which may in one aspect be networked with each other. Networking and automation technology allows for the adjustment of apparatus/asset levels to the exact need to keep the roads safe based on weather conditions, time of day, traffic density and other external factors. In an aspect, a PLC executes an initialization step when placed in run mode, and then repeatedly executes a scan cycle sequence. A basic PLC scan cycle can include three steps, namely an input scan, a user program scan, and an output scan, wherein the total time for one complete program scan is a function of processor speed, I/O modules used, and length of user program. Typically, hundreds of complete scans can take place in 1 second. There are several operating modes for the program to simulate and monitor in the workspace. In another aspect, PLC's programming is based on the logic demands of input devices and the programs implemented are predominantly logical rather than numerical computational algorithms. The PLC system provides a design environment in the form of software tools running on a host computer terminal which allows ladder diagrams to be developed, verified, tested, and diagnosed.

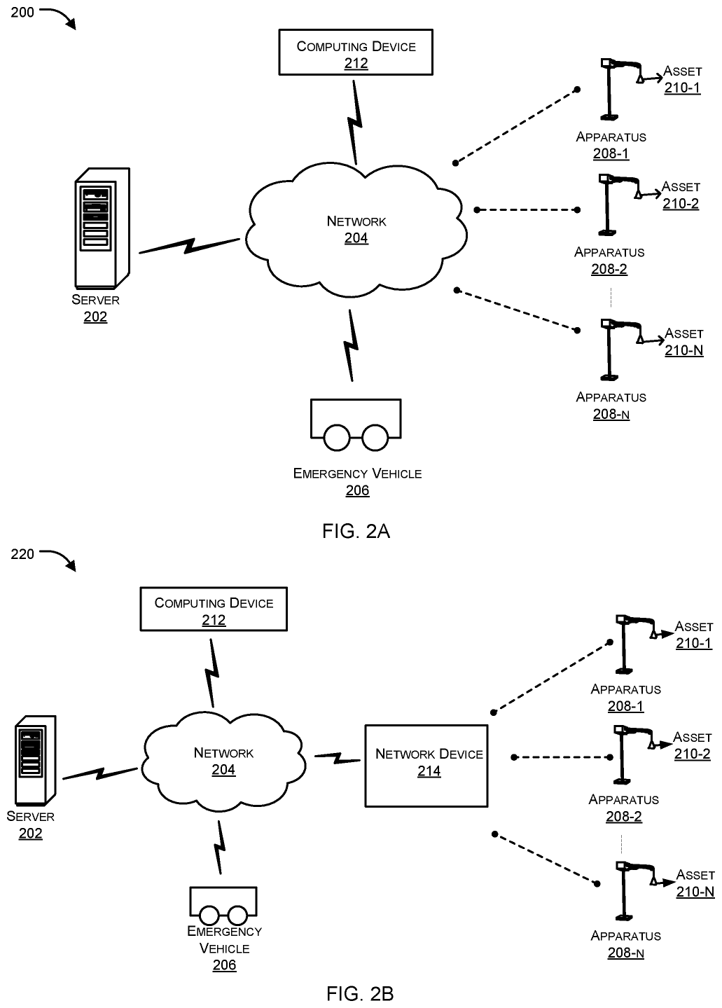

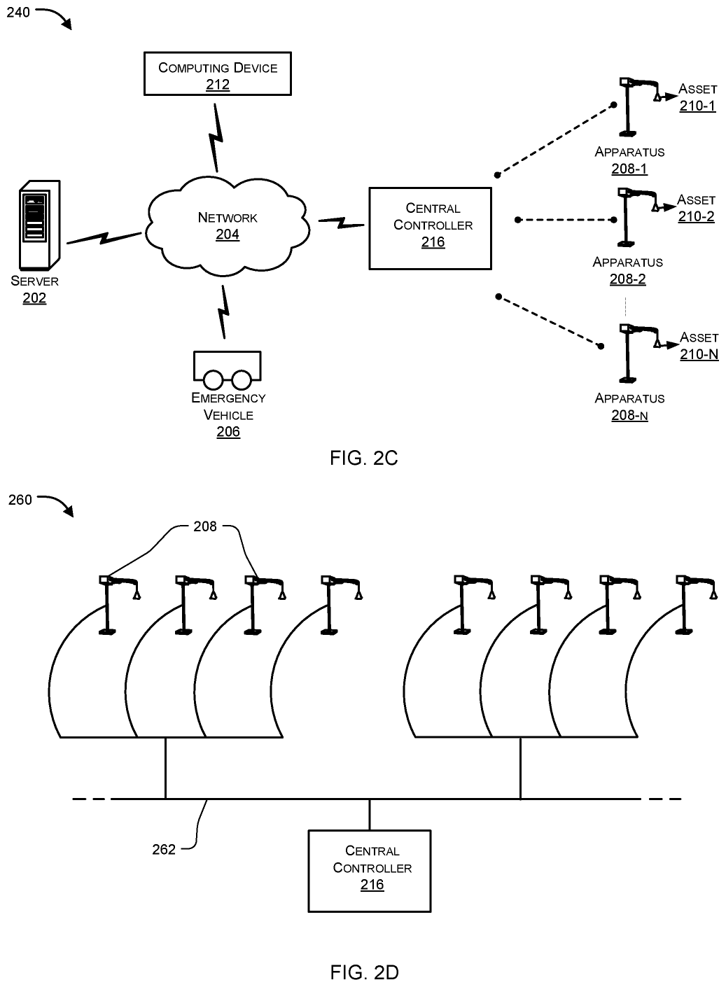

FIGS. 2A-D illustrate exemplary architectures for controlling the proposed apparatus in accordance with an embodiment of the present disclosure.

As illustrated, in a network implementation, a plurality of apparatuses 208-1, 208-2 . . . 208-N (collectively referred to as apparatuses 208 and individually referred to as apparatus 208 hereinafter) can be communicatively coupled with a server 202, a computing device 212 and an emergency vehicle 206 through a network 204. The apparatuses 208 can include respective assets 210-1, 210-2 . . . 210-N (collectively referred to as assets 210 and individually referred to as asset 210 hereinafter). The network 204 can be a wireless network, a wired network or a combination thereof that can be implemented as one of the different types of networks, such as Intranet, Local Area Network (LAN), Wide Area Network (WAN), Internet, and the like. Further, the network 204 can either be a dedicated network or a shared network. The shared network can represent an association of the different types of networks that can use variety of protocols, for example, Hypertext Transfer Protocol (HTTP), Transmission Control Protocol/Internet Protocol (TCP/IP), Wireless Application Protocol (WAP), and the like.

In an embodiment, the asset 210 can be deployed after the apparatus 208 receives a deployment instruction from the computing device 212, for instance, deployment of the asset 210 can take place when the communication unit of the proposed apparatus receives trigger signals/deployment instructions. Examples of the computing device can include, but are not limited to, a server, a cloud, a network device, a smart phone, a portable computer, a personal digital assistant, a handheld device, a power line communication data concentrator and the like.

In an embodiment, a server 202 or the computing device 212 can receive real-time location co-ordinates of the emergency vehicle 206 and can accordingly send trigger signals/deployment instructions to the assets 210. The computing device 212 can receive location coordinates of the emergency vehicle 206 using Automatic Vehicle Location (AVL) system configured at the emergency vehicle 206 that automatically determines and transmits the current geographic location of the vehicle 206. In an embodiment, the location of the vehicle can be determined using Global Positioning System (GPS) and the determined location can be transmitted using any or a combination of transmission mechanisms, including but not limited to, Short Message Service (SMS), General Packet Radio Service (GPRS), satellite or terrestrial radio systems, active Radio-frequency identification (RFID) systems, cooperative real-time location system (RTLS) systems, and the like. Once the computing device 212 receives real time location coordinates, the computing device can transmit trigger signals to the apparatuses installed in the proximity of the current geographic location of the emergency vehicle 206.

In an embodiment, the computing device 212 can be configured in the emergency vehicle 206 such that the computing device 212 configured in the vehicle 206 can send deployment instructions to the apparatus 210 that are in close proximity of the emergency vehicle 206. In an instance, the computing device 212 configured in the emergency vehicle 206 can include an interface or a plurality of interfaces that can be used for input and output of the data. The interface can facilitate communication of the driver of the emergency vehicle 206 with network architectures represented in FIGS. 2A and 2B. The interface can be used to provide a destination location to the computing device 212 and can also be used for displaying path to the driver of the emergency vehicle 206.

In an embodiment, the computing device 212 can receive current location and destination location of the vehicle 206 and based on said locations the computing device 212 can determine an optimal travel path for the emergency vehicle 206. In an embodiment, the path can be determined using a Global Positioning System (GPS) or any other satellite navigation system configured with the vehicle 206. Based on the travel path determined by the computing device 212, deployment instructions can be transmitted to the apparatuses 208, which are in path of the emergency vehicle 206.

In an embodiment, the deployment instructions can be sent to the apparatuses 208 which are in close proximity of the vehicle. In another embodiment, the deployment instructions can be sent to all apparatuses which are in the path of the emergency vehicle 206, such that the microcontroller that can be configured in the apparatuses can set an appropriate time for performing switching for deployment of the assets 210 when the vehicle reaches in the proximity of the apparatus 208.

In an embodiment, the computing device 212 can enable alternate switching for deployment of assets of the apparatuses 208 to reduce power consumption.

In an embodiment, the plurality of apparatuses 208 which are in close proximity can be deployed with a single deployment instruction sent to a network device 214. Examples of network device 214 can include, but are not limited to a gateway device, a programmable logic controller, RF nodes, a hub, a router, a relay device and the like. Further, the network device 214 can include a switch that can be used to deploy a set of assets 210 which are in close proximity with each other.

In an embodiment, the asset 210 can be deployed at a first pre-defined time before said emergency vehicle arrives at the asset 210. For example, based on the deployment instructions, the asset 210 can be deployed when the emergency vehicle 206 reaches at a distance of 500 meters from the apparatus 208. Further, the asset 210 can return back to the first/normal position at a second pre-defined time after passing by of the emergency vehicle 206. For example, the asset 210 can be returned to the first/normal position after a period of say 30 seconds when the emergency vehicle crosses the asset 210.

In embodiment, communication through network 204 can be based on any or a combination of communication techniques including, but not limited to radio frequency communications, optical communications, power line carrier communications and the like.

In an embodiment, the apparatuses 208 can be connected in series, wherein asset 210 of each apparatuses 208 can be deployed for a pre-determined time slot in a systematic manner to create a dedicated lane for an emergency vehicle 206. The time slot allotted to a plurality of apparatuses 208 can be kept such that when the first asset 210 is deployed, after a predetermined time, or immediately thereafter, a second asset 210 of a second apparatus 208 can be deployed. Thus forming a division on the road to provide a separate passage to the emergency vehicle.

It would be appreciated that switching of the apparatuses 208 to deploy the assets 210 can be performed using a suitable control system such as, but not limited to, Supervisory Control and Data Acquisition (SCADA) control system, power-line communication control system. FIGS. 2C-D illustrate exemplary architectures for controlling deployment of assets based on power line communication. In an aspect, the proposed apparatus 208 having the asset 210 can include a control unit/circuit that is connected to a power source/supply along with comprising a power line communication transceiver (referred to as PLC transceiver hereinafter) electrically coupled to the control circuit and the power line. The control circuit controls electrical power supplied to the apparatus for working of the motor and consequent deployment of the asset 210. A central controller 216 can be connected to the electrical distribution network 262 via PLC transceiver, wherein the central controller 216 can control and monitor operation of each apparatus 20/asset 210 connected to the electrical distribution network 262 by sending control commands to each apparatus (which may be integrally coupled with or integrated with a respective/corresponding street lamp), and receives status information there from via the PLC transceiver. In an embodiment, the central controller 216 can be coupled to the network 204 such that a data communication bridge is established between the central controller 216 and the computing device 212 such that deployment instructions can be obtained from the computing device 212.

In an exemplary implementation, when PLC transceiver receives an incoming data packet sent by the central controller 216 via the power line communication network. The PLC transceiver of one or multiple apparatuses can be connected to a PLCC (power line communications data concentrator) in a power line communication network, such that central controller will communicate instructions/data signals to a PLCC which will transmit to plurality of PLC transceiver connected to that PLCC. The PLC transceiver can first demodulate the data signal (carrying instructions to activate the asset deployment) from the power line and send the information to the control circuit configured in respective apparatus 208. In one embodiment, the data packet comprises at least one unique identification code of the apparatus 208, a command for the apparatus 208 to execute deployment, and optionally some parameters associated with that command. The control circuit then examines the unique identification code such that if this matches that of the apparatus 208, the control circuit executes the command, wherein the command may be either to switch on/deploy the asset 210 of the apparatus 208, to switch off/un-deploy the asset 210 of the apparatus 208, or to modify the attributes such as height, length, width, audio parameters to a value specified by the parameters. The control circuit then controls the power supply that supplies power to the apparatus 208. Meanwhile, the control circuit of an individual apparatus can also send status information together with its unique identification code via the PLC transceiver back to the central controller 216, so that the central controller 216 can monitor the well-being of each apparatus 208.

In an aspect, one or more apparatuses can be controlled using relays and/or circuits such as switches, DPDTs (double-pole, double-throw), SPST (Single Pole, Single Throw), SPDT (Single Pole, double-throw), or any combination thereof so as to perform outputs from variable inputs of current or voltage modulations. A circuit can be logically constructed using resistors, semiconductors, relays such as actuator relays, logic gates, clock/timer, diodes such as zener diode and combination thereof, is connected to the switch for triggering various pre-defined functions. A monitoring circuit which can comprise a combination of operational amplifiers, comparators, transistors, voltage regulators, actuator relays, high pass and low pass band filters, differential amplifier, op-amp circuit etc. provides the switch with a signal indicative of the line voltage of the power line. Switch may trigger various pre-defined functionalities as outputs, depending on variable voltage/current input in power line. In an example, a switch can be used to initiate control circuit for performing such actions and/or controlled use to motor. The control circuit executes the command, wherein the command may be either to switch on/deploy the asset 210 of the apparatus 208, to switch off/un-deploy the asset 210 of the apparatus 208, or to modify the attributes such as height, length, width, audio parameters to a value specified by the variable voltage/current input in power line.

In one embodiment, all the components, including the electronic parts mentioned above, of the apparatus 208 can be made to the same dimension of a conventional street lamp so that it can fit to the existing street lamp socket and housing. As such, by replacing existing street lamps with the apparatus 208, and by adding the computer server and the corresponding PLC transceiver at the server end, an operator can instantly control and monitor each individual street lamp within the network.

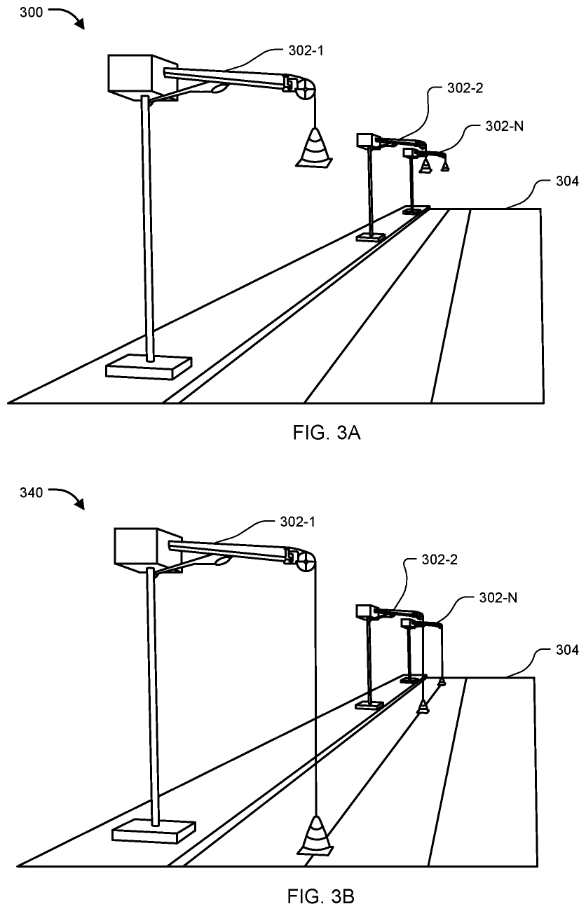

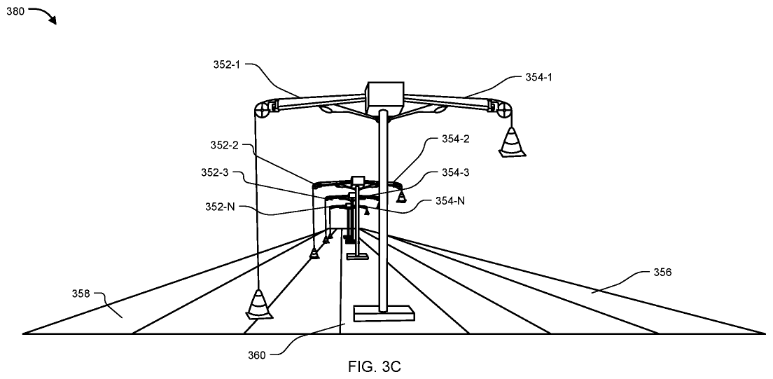

FIGS. 3A-C illustrate exemplary representations for creation of a dedicated lane for an emergency vehicle in accordance with an embodiment of the present disclosure.

As illustrated in FIGS. 3A-B, a road 304 can have multiple lanes, where each lane is designated for use by a single line of vehicles to reduce traffic conflicts. Plurality of apparatuses 302-1, 302-2, . . . , 302-N (collectively referred to as apparatuses 302 and individually referred to as apparatus 302 hereinafter) can be configured with multiple street lights that are mounted on edge of the road 304. FIG. 3A illustrates normal position of the apparatuses 302.

The apparatus 302 can receive deployment instruction from a computing device or power line communication concentrator. In an embodiment, when an emergency vehicle is in proximity of apparatus 302, the asset of the said apparatus 302 can be deployed. The deployed position of the assets of the apparatuses 302 is illustrated in FIG. 3B. As illustrated, when the assets of the apparatuses 302 are in deployed position, a separate passage can be created to provide an uninterrupted path for the emergency vehicle to pass through. In an embodiment, after a pre-defined time interval, the assets of the apparatuses 302 can be brought back to the normal position, thereby, making all lanes of the road available for other vehicles.

In an embodiment, apparatuses 302 of the present disclosure can be configured with street lights mounted on divider separating two sides of the road, where each side of the road can include multiple lanes. As illustrated in FIG. 3C, 358 and 356 represent two sides of a road separated by a divider 360. The apparatuses 352-1, 352-2 . . . 352-N can be used for creating a dedicated lane on the side 358 of the road, and the apparatuses 354-1, 354-2 . . . 354-N can be used for creating a dedicated lane on side 356 of the road.

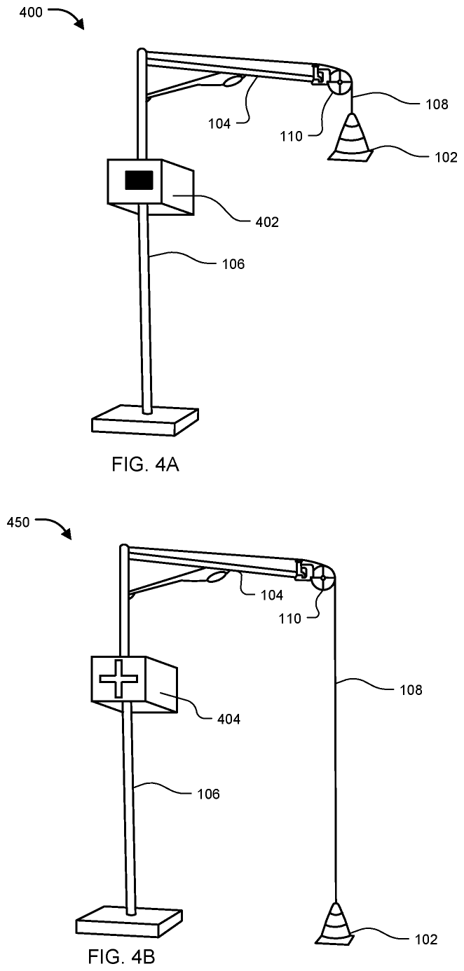

FIGS. 4A-B illustrate exemplary representations indicate an alarming system operatively coupled with the proposed apparatus in accordance with an embodiment of the present disclosure.

In an embodiment, the apparatus of the present disclosure can be operatively coupled with an alarming system 402 that can comprise any or a combination of a display, a light, and the like. Additionally or alternatively, the alarming system 402 can be configured to generate an audio signal to alert other vehicles on the road about the proximity of emergency vehicle. Further, the alarming system can be used for instructing other vehicles to vacate the dedicated lane that is being created for emergency vehicle.

In an embodiment, at normal times, display of the alarming system 402 can be used for displaying informative content such as advertisements, weather reports, general awareness content etc. However, in event of an emergency situation, that is the situation when an emergency vehicle has to pass through, the same display can be used to indicate a warning/alert to other vehicles. For example, a medical sign can be displayed as indicated at 404 when an ambulance has to pass through, such that all other vehicles on the road are notified to vacate the dedicated lane. Similarly, different signs can be used for indicating different emergency situations. In an embodiment, the switching between the informative content and the warning/alert can be performed using the motor that can be further used for deployment of the asset. In another aspect, a motor can be configured to rotate a display from a non-display configuration/position to a display configuration/position such that the vehicles can be displayed warning/caution or any other message indicative of the fact that an emergency vehicle is coming soon. Any other mechanical/electrical way of showing a message indicative of the emergency vehicle arriving is well within the scope of the present disclosure. In an aspect, the display can include a housing that may be fabricated from plexiglass, glass, acrylic or any other transparent material, wherein the housing can be in the shape of a cylinder/square/rectangle, however, any suitable or attractive shape may be used. The housing may have a hinged opening which permits access to the display components. Within the housing can be configured a drive motor that serves to rotate a lower shaft at a selected speed of say between 300 and 3000 RPM. The actual speed may vary with the size, shape and color of the display. In an aspect, rotational velocity can be chosen so as to take advantage of the persistence of vision in the viewer's eye. In another aspect, the display can be generated from a light array with a column of modulated light emitting elements, wherein the column is mounted on a rotating display assembly. Power and data can be combined on a fixed control assembly and inductively coupled to the display assembly. A control assembly processor can be configured to interpret a display application language that describes display-specific tasks to generate command, mode, character and graphic data for the display assembly. The control assembly processor also reads a trigger position sensor and adds a trigger delay to generate a virtual trigger command, which provides for flexible display positioning and scrolling display effects.

In an embodiment, the alarming system 402 can include a plurality of display units such as screens/banners and the informative content can be displayed on each of the screens/banners. In an embodiment, the motor that is used to deploy the assets can be configured with a transmission mechanism to transmit mechanical power so as to enable switching of the plurality of screens/banners of the alarming system 402 to allow switching between the informative content.

Also, in an embodiment, the speed of motor of the said apparatus can be kept low, such that slow descent of the asset can provide appropriate time to alert other vehicles on the road and the other vehicles can suitably change the lane. In an embodiment, the assets can be deployed at an intermediate position in order to alert the other vehicles to vacate the lane for creating a dedicated lane providing an uninterrupted passage for the emergency vehicle. In an embodiment, the alarming system 402 can provide information related to estimated time for arrival of the emergency vehicle and can further provide information about expected time for clearing of the dedicated lane so that other vehicles can the road can be informed of the expected time involved in un-establishment of the dedicated lane.

In an aspect, power supply for the proposed apparatus can be supplied from electric wire that is similar or same as that of the streetlight. In another aspect, a programmable logic controller/switch can take inputs from power line for power supply via power line communication.

In another aspect, an RF antenna, RFID or RF control circuit can be configured on the apparatus such that the apparatus is able to efficiently detect when the emergency vehicle passes through said apparatus from RF frequencies of the pre-defined emergency vehicle, based on such detection, the apparatus can perform desired operation such as pull back the asset to its initial/first position etc.

In yet another aspect, width (horizontal length) of the proposed apparatus can be varied through telescopic means such that when the asset is deployed, the width can indicate how broad/wide the created lane is. For instance, the width can be enhanced for a fire truck and can be relatively shorter for an ambulance.

In another aspect, each apparatus can be associated with a unique identifier, based on which it can be controlled/deployed. Also, each apparatus can have two sides such that when the apparatus is configured in the central divider of the road, one side can have one asset (having, for instance, a first sub-identifier) to be deployed on one side of the road, and a second asset (having for instance a second sub-identifier) to be deployed on the other side of the road. This can help the proposed server/system/emergency vehicle to select any or both of the two assets to be deployed upon actuation using the sub-identifiers.

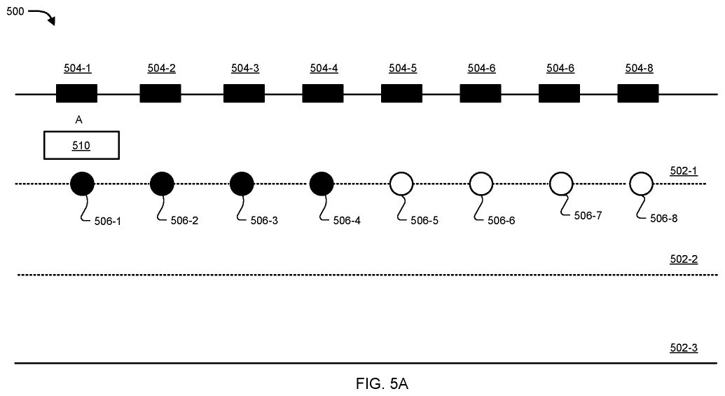

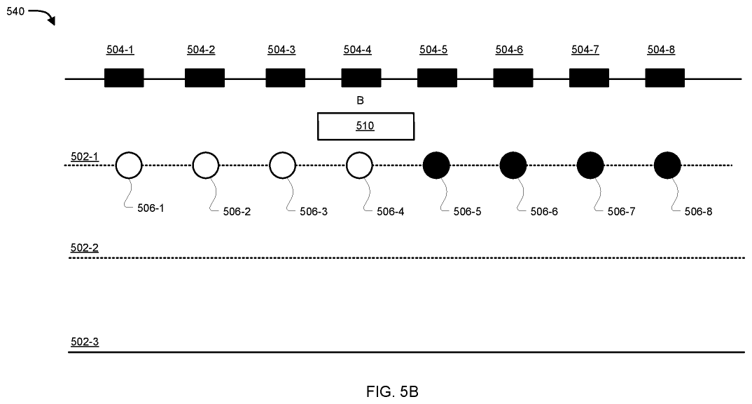

FIGS. 5A-C illustrate exemplary representations for deployment of assets according to passage of an emergency vehicle in accordance with an embodiment of the present disclosure.

FIGS. 5A and 5B illustrate a road from which an emergency vehicle is required to pass through. The road can comprise multiple lanes (For example, 502-1, 502-2, 502-3). Plurality of apparatuses 504-1, 504-2 . . . 504-8 with respective assets 506-1, 506-2 . . . 506-N can be configured on edge of the road. The assets 506-1, 506-2 . . . 506-8 represented by black circles the can indicate deployed position while the assets represented by white circles can indicate normal position.

In an embodiment, a network device can trigger switching signal for a set of apparatuses that are in close proximity. For example, a set of four consecutively placed apparatuses 504-1, 504-2, 504-3 and 504-4 can be switched using one network device (ND1). Similarly, another set of four consecutively placed apparatuses 504-5, 504-6, 504-7 and 504-8 can be switched using a second network device (ND2) and so on.

As illustrated in FIGS. 5A and 5B, when the emergency vehicle reaches position A, the assets 506-1, 506-2, 506-3 and 506-4 of the first set of apparatuses 504-1, 504-2, 504-3 and 504-4 can be deployed using ND1. Similarly, when the emergency vehicle reaches position B, the assets 506-1, 506-2, 506-3 and 506-4 of the first set of apparatuses 504-1, 504-2, 504-3 and 504-4 can return back to the normal position and the assets 506-5, 506-6, 506-7 and 506-8 of the second set of apparatuses 504-5, 504-6, 504-7 and 504-8 can be deployed.

FIG. 5C illustrates apparatuses 508-1, 508-2, 508-3 . . . 508N mounted on divider separating two sides of the road. When an emergency vehicle has to travel from point C to point D through points E, F and G, the apparatuses 508-1, 508-2, 508-3, 508-4, 508-5, 508-14, 508-15, 508-16 and 508-17 can systematically deploy their respective assets to provide a dedicated lane for passage of the emergency vehicle. Further one or multiple assets which are in proximity of each other can be deployed simultaneously.

In an example, assets of apparatuses 508-1, 508-2 and 508-3 can be deployed using network device 1 (ND1), assets of apparatuses 508-4 and 508-5 can be deployed using network device 2 (ND2), asset of apparatus 508-14 can be deployed using network device 3 (ND3), and assets of apparatuses 508-15, 508-16 and 508-17 can be deployed using network device 4 (ND4).

While travelling from position C to position D, in an example, when the emergency vehicle is at position C, ND1 can deploy assets of the apparatuses 508-1, 508-2 and 508-3. At the same time, ND2 can initiate deployment of the assets of apparatuses 508-4 and 508-5 in an intermediate/ready position, where the assets of apparatuses 508-4 and 508-5 are at an intermediate height such that the assets of apparatuses 508-4 and 508-5 do not interfere with the incoming traffic and can alert other vehicles of the incoming traffic of the deployment of the assets to provide the other vehicles with adequate time to switch the lane that is to be reserved for the emergency vehicle. As soon as the emergency vehicle reaches position E, the assets of apparatuses 508-4 and 508-5 can get deployed on the road so as to create the dedicated lane for the emergency vehicle.

Further, when the emergency vehicle reaches position E, the assets of the apparatuses 508-1, 508-2 and 508-3 can be brought back to the normal position and the assets of apparatuses 508-4 and 508-5 can be deployed on the road using ND2 and the asset of the apparatus 508-14 can be deployed to the intermediate position using ND3. Similarly, when the vehicle has to take a turn at position F, the asset of the apparatus 508-14 can be deployed on the road using ND3 and the assets of the apparatuses 508-4 and 508-5 can be brought back to normal position. At this instance, the assets of the apparatuses 508-15, 508-16 and 508-17 can be deployed to the intermediate position using ND4. Again, when the emergency vehicle has to take a turn from point G, assets of the apparatuses 508-15, 508-16 and 508-17 can be deployed on the road using ND4 and the asset of the apparatus 508-14 can be brought back to the normal position once the emergency vehicle crosses point G.

Exemplary deployment of assets with reference to position of the emergency vehicle, when the emergency vehicle travels from position C to position D is indicated in the Table 1:

TABLE 1

| Position of the | Position of the Assets | | | |
|---|---|---|---|---|
| emergency | 508-1, 508-2, | 508-4 | | 508-15, 508-16 |
| vehicle | and 508-3 | and 508-5 | 508-14 | and 508-17 |
| C | Deployed | Ready | Initial | Initial |
| E | Initial | Deployed | Ready | Initial |
| F | Initial | Initial | Deployed | Ready |
| G | Initial | Initial | Initial | Deployed |
| D | Initial | Initial | Initial | Initial |

Thus, systematic deployment of the assets of the apparatuses 508-1, 508-2, 508-3, 508-4, 508-5, 508-14, 508-15, 508-16 and 508-17 ensure an uninterrupted and safe passage to the emergency vehicle, such that the response time of the emergency vehicle is highly reduced and the emergency vehicle experiences least interference with the traffic on the road.

It would be appreciated that although above-mentioned implementations relate to deployment of the asset based on receipt of a trigger signal from a computing device or a from a server or from the emergency vehicle itself or from controller via power line communication, such asset deployment can be implemented through any other means and therefore such means are not limited to the above-mentioned exemplary implementations in any manner. For instance, an asset can be deployed based on detection of sound/alarm generated by the emergency vehicle, or can be detected through a camera that is configured in the apparatus such that the camera captures images of upcoming traffic and detects an approaching emergency vehicle. In another instance, radio frequency from emergency vehicle can be used to trigger deployment of the assets, in such an instance the apparatus can receive RFID of incoming vehicle thus can uniquely recognize the pre-defined vehicle and deploy concerned assets from notified apparatuses. Such a trigger/activation/deployment signal can also be received from the hospital that the emergency vehicle pertains to and therefore all of these are exemplary implementations. In another aspect, the presence of an emergency vehicle may be detected based on a number of monitored vehicles performing the same or a similar action. The action may be changing lanes, pulling over, slowing down, speeding up, braking, switching a blinker on, etc. Two actions may be considered similar if they happen in close temporal proximity and/or if they have similar direction (e.g., vehicles moving from the left lane to the right lane, etc.). In yet another aspect, the emergency vehicle may be detected using an array of sensors, such as cameras, microphones, or laser scanners. For example, image recognition techniques may be employed to distinguish emergency vehicles, such as police cars, fire trucks, or ambulances, from other vehicles on the road. Alternatively, microphones can be used to detect emergency vehicles' sirens. For example, the microphone may be used to record and identify sounds at frequencies and patterns known to be used by emergency vehicles. As yet another alternative, a laser scanner may be used to obtain 3D representations of vehicles on the road and those representations may then be compared to known representations of emergency vehicles.

In an aspect, the emergency vehicle can include any or a combination of a GPS, an in-vehicle communication device, front and rear sensors, a navigation system so to directly/operatively communicate with the central server or directly with the apparatus (or a group of apparatuses). The GPS (Global Positioning System) can receive signals from a plurality of GPS satellites using a GPS receiver and measures the position of the emergency vehicle from the difference between the signals. The in-vehicle communication device can be a communication device that performs vehicle-to-vehicle communication with other vehicles and road-to-vehicle communication with a road-side infrastructure such as an optical beacon. The front and rear sensors can be, for example, millimeter-wave radars or ultrasonic sonars that detect the position and moving speed of pedestrians, two-wheeled vehicles, bicycles, and vehicles around the vehicle, and road-side facilities such as stores. The navigation system can guide the route of the emergency vehicle using the GPS and a map information DB (Database) that is provided in the host vehicle and stores map information.

In another aspect, before deployment of the asset, a pre-defined time and a visual/audio notification can be given to normal traffic vehicles so as to allow them to move away from the dedicated lane that would eventually be created after the pre-defined time, so as to allow sufficient and safe transition time for the normal vehicles to move away from the lane.

In an aspect, of the present disclosure, driver of the emergency vehicle can include an operator of a vehicle. A driver of a vehicle may include, but is not limited to, a human, an autonomous driving system, any computer-based vehicle driving system or combinations thereof. An autonomous driving system includes driving system of a driverless vehicle, a robot system, and a computer system installed in a vehicle or operating remotely. In certain preferred embodiments, a driver may also include a bicycle rider, a motor cycle rider or a driver of a surface vehicle.

Similarly, server (server system/computer server system) can include a computer system with appropriate hardware and software installed, and appropriately configured to process data including navigation data and responses for requests received from other systems (computing devices or software systems). In an exemplary embodiment, a client-server model may be implemented with user devices being the clients and the server system performs the functions of a server.

In yet another aspect, emergency vehicle, in context of the present invention, can include a fire truck, a police car, or any other vehicle for which a dedicated lane may be desired.

In another aspect, properties of the lane created can be varied based on desired configuration and applicable rules, wherein, for instance, such properties can include width, length, direction of travel, allowed speed, among other like attributes.

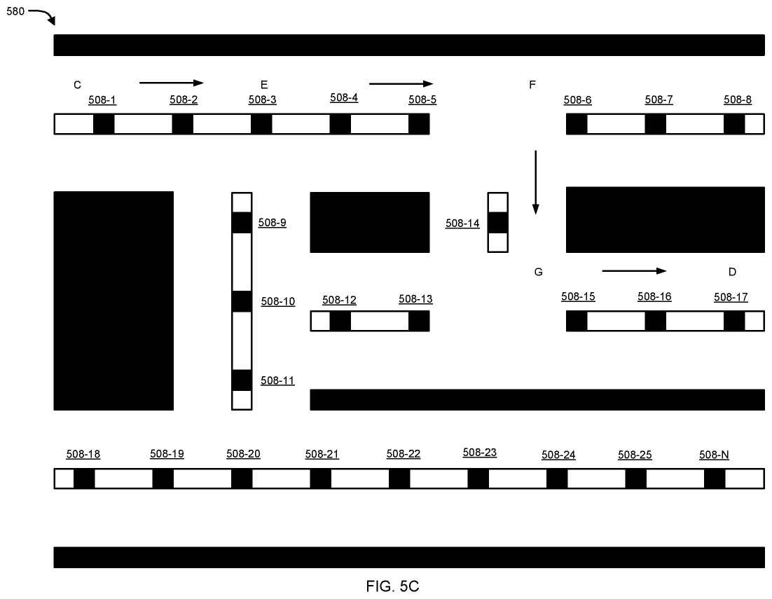

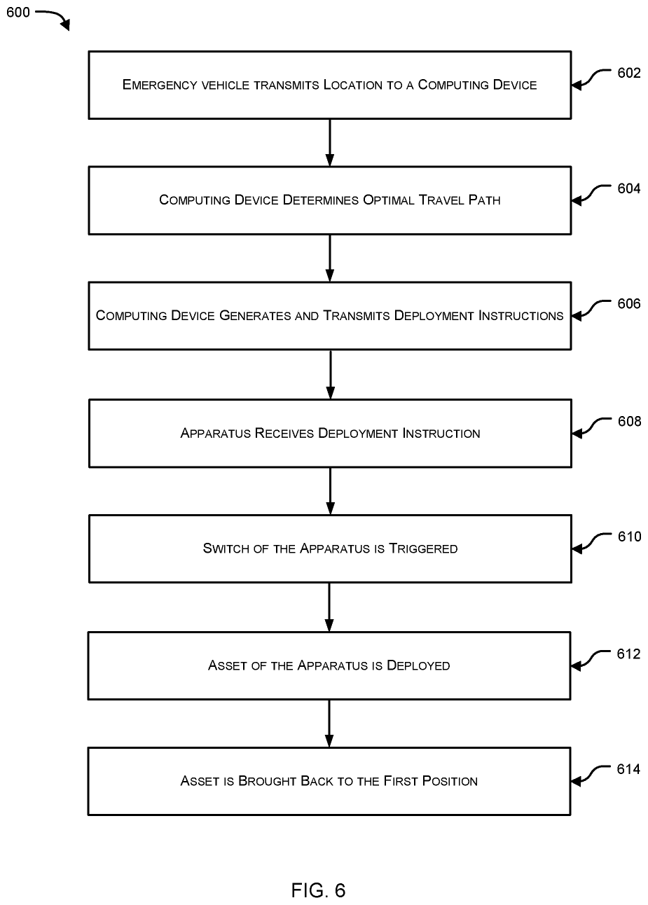

FIG. 6 is a flow diagram illustrating a process for creation of an uninterrupted passage for an emergency vehicle in accordance with an embodiment of the present disclosure.

In an aspect, for creation of an uninterrupted passage for an emergency vehicle, at step 602, the emergency vehicle can transmit current location and desired location to a computing device. In an embodiment, the desired location can be provided manually by providing location/address of the destination to the computing device. In another embodiment, based on the current location, the computing device can compute the desired location. For example, if the emergency vehicle is an ambulance that is carrying a patient, the computing device can indicate a nearest hospital as the desired location. Furthermore, the computing device can also prioritize passing of an ambulance in case a plurality of ambulances have to pass through the dedicated lane. For instance, the computing device can prioritize movement of the plurality of ambulances based on injury severity score (ISS) of a patient provided by an operator and can enable an ambulance associated with a higher ISS to pass through the dedicated lane prior to passing of other ambulances associated with a lower ISS.

Further, at step 604, the computing device can determine an optimal travel path based on the current location and the desired location of the emergency vehicle. Thus, the computing device can determine when the emergency vehicle is approaching a defined location. Based on the determined optimal path for the emergency vehicle and distance of the emergency vehicle from the defined location, at step 606, computing device can generate deployment instructions. In an embodiment, when the emergency vehicle reaches in close proximity of the apparatus, say at a distance of 500 meters, the deployment instructions can be transmitted to the apparatus. At step 608, the apparatus can receive the deployment instructions using communication unit. On receiving the deployment instructions, at step 610, the switch of the apparatus can be triggered, thereby deploying the asset at step 612. When the emergency vehicle passes through the apparatus, the asset can be brought back to the normal position at step 614 Embodiments of the present disclosure include various steps, which have been described above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

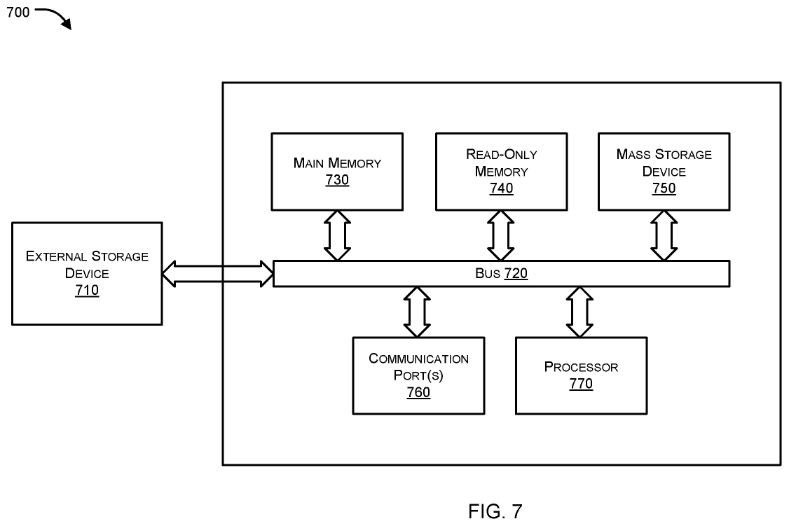

FIG. 7 illustrates an exemplary computer system utilized for controlling deployment of an asset in accordance with embodiments of the present disclosure.

In an embodiment, asset of the proposed apparatus can be deployed after the proposed apparatus receives a deployment instruction from a computing system/device through a wireless or a wired connection. As shown in FIG. 7, computer system can include an external storage device 710, a bus 720, a main memory 730, a read only memory 740, a mass storage device 750, communication port 760, and a processor 770. A person skilled in the art will appreciate that computer system may include more than one processor and communication ports. Examples of processor 770 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 770 may include various modules associated with embodiments of the present invention. Communication port 760 can be any of an RS-232 port for use with a modem based dialup connection, a 10/100 Ethernet port, a Gigabit or 10 Gigabit port using copper or fiber, a serial port, a parallel port, or other existing or future ports. Communication port 760 may be chosen depending on a network, such a Local Area Network (LAN), Wide Area Network (WAN), or any network to which computer system connects.

Memory 730 can be Random Access Memory (RAM), or any other dynamic storage device commonly known in the art. Read only memory 740 can be any static storage device(s) e.g., but not limited to, a Programmable Read Only Memory (PROM) chips for storing static information e.g., start-up or BIOS instructions for processor 770. Mass storage 750 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7102 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 720 communicatively couples processor(s) 770 with the other memory, storage and communication blocks. Bus 720 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 770 to software system.

Optionally, operator and administrative interfaces, e.g. a display, keyboard, and a cursor control device, may also be coupled to bus 720 to support direct operator interaction with computer system. Other operator and administrative interfaces can be provided through network connections connected through communication port 760. External storage device 710 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claim.

In the foregoing description, numerous details are set forth. It will be apparent, however, to one of ordinary skill in the art having the benefit of this disclosure, that the present invention may be practiced without these specific details. In some instances, well-known structures and devices are shown in block diagram form, rather than in detail, to avoid obscuring the present invention.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

### ADVANTAGES OF THE PRESENT DISCLOSURE

The present disclosure provides an apparatus that can enable temporary creation of a dedicated lane on the road for providing an uninterrupted passage to an emergency vehicle.

The present disclosure provides an apparatus that can ensure safe and quick passage to an emergency vehicle.

The present disclosure provides an apparatus that can notify vehicles other than the emergency vehicle for immediate attention.

The present disclosure provides an apparatus that can indicate a passage to other vehicles such that an emergency vehicle can pass through a dedicated passage.

The present disclosure is to provide an apparatus that can be integrated with existing structures, which are installed on the road.

We claim:

1. An apparatus comprising a deployable asset that is configured in a first position and in a second position, said first position being configured when said asset is not deployed and hangs vertically by means of a support mechanism, said second position being configured when said asset is deployed on a road by being vertically brought down from said first position such that upon deployment, said asset enables temporary creation of a dedicated lane on the road to enable uninterrupted passage of a defined vehicle.

2. The apparatus of claim 1, wherein said defined vehicle is selected from a set of vehicles comprising any or a combination of emergency vehicles, ambulances, and vehicles designed as requiring the uninterrupted passage for passing through.

3. The apparatus of claim 1, wherein said asset is deployed in conjunction with deployment of a set of assets that are in proximity to said apparatus.

4. The apparatus of claim 1, wherein said asset is deployed at a first trigger event or at a first pre-defined time before said defined vehicle arrives at the asset, and returns back to the first position at a second trigger event or at a second pre-defined time after passing by of the vehicle.

5. The apparatus of claim 1, wherein the asset is deployed after said apparatus receives a deployment instruction from a computing device, said instruction being received through a wireless or a wired connection.

6. The apparatus of claim 5, wherein the computing device is a server or cloud that is operatively coupled with the vehicle, and upon receiving real-time location coordinates of the vehicle, said computing device issues said deployment instruction to the apparatus.

7. The apparatus of claim 5, wherein said computing device is configured in the vehicle.

8. The apparatus of claim 5, wherein the computing device receives destination location from said vehicle, and based on current location of said vehicle and said destination location, determines an optimal travel path for said vehicle, and issues one or more deployment instructions to respective apparatuses based on said determined optimal travel path.

9. The apparatus of claim 1, wherein said asset is a traffic cone marker.

10. The apparatus of claim 1, wherein said apparatus is operatively coupled with a street light.

11. The apparatus of claim 1, wherein said asset is moved between said first position and said second position using a pulley/motor system.

12. The apparatus of claim 1, wherein said asset has a reflective surface for visibility at night.

13. The apparatus of claim 1, wherein said asset comprises any or a combination of a display, a light, or is configured to generate an audio signal to alert other vehicles on the road that said vehicle is approaching and instructing emptying of said dedicated lane.

14. The apparatus of claim 1, wherein said apparatus of claim 1, wherein said apparatus is operated by means of a switch, activation of which deploys said asset on the road.

15. A system configured to enable systematic deployment of an asset that is positioned at a defined location from a first position to a second position, said systematic deployment being done upon said system receiving a signal representative of a defined vehicle approaching said defined location, said first position being configured when said asset is not deployed and hangs vertically by means of a support mechanism, said second position being configured when said asset is deployed on a road by being vertically brought down from said first position such that upon said systematic deployment, said assets enables temporary creation of a dedicated lane on the road to enable uninterrupted passage of said defined vehicle.

16. A method comprising:
receiving, at a computing device, a signal representative of an defined vehicle approaching a defined location; and
enabling, using said computing device, deployment of an asset that is operatively coupled with said computing device and positioned at said defined location from an initial position to a desired position, said initial position being configured when said asset is not deployed and hangs vertically by means of a support mechanism, said desired position being configured when said asset is deployed on a road by being vertically brought down from said initial position such that upon deployment, said asset enables temporary creation of a dedicated lane on the road to enable uninterrupted passage of said defined vehicle.
